(19) United States
(12) Patent Application Publication
(10) Pub. No.: US 2007/0208118 A1
(43) Pub. Date: Sep. 6, 2007

(54) Thermoplastic Filling Mixture and use of the Filling Mixture

(76) Inventor: Markus Hirschi, Rickenbach (CH)

Correspondence Address: NOTARO AND MICHALOS, 100 DUTCH HILL ROAD, SUITE 110, ORANGEBURG, NY, 10962-2100, US

(21) Appl. No.: 10/592,652

(22) PCT Filed: Mar. 24, 2005
(86) PCT No.: PCT/CH05/00174

§ 371 Date: Mar. 19, 2007

(30) Foreign Application Priority Data
Mar. 24, 2004 (CH) 493/04

(51) Int. Cl. C08K 7/16; C08L 91/06; C08L 91/08

(52) U.S. Cl. 524/277; 524/487; 523/223

(57) ABSTRACT

The invention relates to a thermoplastic filler mixture comprising a polymer part, a wax part, a resin part, and at least one modifying agent.

The invention concerns a thermoplastic filling mixture on polymer basis and the use of such a filling mixture.

It is well-known that there are most diverse glues and fillings, which depending upon area of application and requirements specification are used. Polymers, like for example the well-known Polyurethan, rank among the materials, which serve as raw material for coating materials, sealing materials, sealing compounds and foams in numerous applications. In order to improve such a raw material, be it now a coating, a sealing material, injection resin etc. regarding the demanded characteristics, aromatic hydrocarbon resins are employed as modifying agents. Due to their characteristics they serve for the product optimization in Polyurethan systems.

For filling and repairing parquet planks so far an adhesive is used on Polyamide basis. Such an adhesive is however strongly abrasiv. Tools, which are used for reworking, thus show relatively fast wear. Particularly sanding belts wear out faster, if one sands off parquet planks which were repaired with Polyamide adhesive.

There are different thermoplastic adhesives, which have however the disadvantage that they can be relatively badly drilled, milled, sawed, cut or planed.

A thermoplastic filling material for filling cracks, branch columns and laminar defects and recesses in wood surfaces is mentioned in the European patent application with title ,,procedure for leveling the surface of wood”, which was published under the number EP 1378332 A2. The special attention is directed in this patent application however toward the penetration of the filling material into capillary-like columns. As suitable filling materials vinyl acetate, ethyl vinyl acetate, amorphous polyolefins, Polyurethan and Polyamide are mentioned, without more closely dealing with the filling material. The indicated compounds are standard filling materials, which are used also in numerous other industrial processes.

It is thus an objective to provide a filling mixture places, which is easily applicable, has durably good mechanical characteristics such as adhesion, firmness, elasticity, heat resistance and at the same time can be worked on or worked over with low wear after the application and drying.

The objective is solved by a thermoplastic filling mixture in accordance with claim 1 and a use of a thermoplastic filling mixture in accordance with claim 13.

Further advantageous embodiments are to be inferred from the dependent claims.

### DETAILED DESCRIPTION

Basis of the filling material according to the invention is a new starting mixture from a polymer portion, a wax portion and a resin portion.

The invention is based on the insight that a mixture of the polymer portion with a wax portion and a resin portion (here called starting mixture) supplements, against the expectation of a specialist, the outstanding characteristics of the polymer portion without essentially disturbing it.

The polymer portion can comprise Homopolymers and/or copolymers. The use of copolymers is preferred in accordance with invention. Copolymers are polymers, which consist of different monomers which are regularly statistically or stochastically built into the polymer molecule. Homopolymers however are plastics, which consist only of same monomers.

The polymer portion, which serves among other things as bonding agent in the filling mixture according to the invention, can be polycondensate, e.g. polyesters or Polyaducts, e.g. Polyurethan or preferably polymers, which can be derived by radical or ionic polymerization of ethylenic non-saturated monomers (briefly: Polymers).

The following copolymers are particularly suitable: Vinyl acetate copolymer (VAc-copolymer), Ethen-Ethylacrylat copolymer (E/EA), Ethylene vinyl acetate-copolymer (E/VA), Ethylmethacrylat (EMA), ethylene Butyl acrylate (EBA), ethyls acryl acid (EAA).

A use of E/VA as copolymer leads to the fact that the shatter crack stability of the filling mixture is improved.

The polymer portion has among other things influence on the brittleness of the filler. The starting mixture gets more brittle the smaller the polymer portion becomes. Thus the starting mixture becomes better grindeable. If however the polymer portion is increased, then the starting mixture will get more flexible (less brittle), but it can be ground less well.

As wax portion one or several of the following waxes are employed: Polyolefin wax (polyethylene wax or Polypropylene wax), amide wax, Montan wax, hydrocarbon wax, E/VA wax and mixtures or modifications of these waxes. The most important product properties of the wax portion, like hardness, melting point and viscosity, can be adjusted purposefully depending upon desire within wide limits and combined in various ways. The wax portion can be present as granulate, powder or in flake form. Also liquid of waxes can be used. Both homopolymer as well as copolymers waxes are suitable, whereby homopolymeric waxes deliver better results.

The wax portion has among other things an influence on the viscosity and the melting point of the filling mixture.

Waxes which are manufactured by so-called metallocen catalysts are particularly suitable.

As resin portion natural resins and modified natural resins can be used. Non-modified hydrocarbon resins or aromatic hydrocarbon resins (e.g. resin esters) are particularly suitable.

Depending upon kind of the resin portion the color of the filling mixture can be affected. Further the resin portion affects further characteristics such as thermal and UV stability, evaporation loss or compatibilities with the other components of the filling mixture.

The hydrocarbon resins can be present in liquid or firm form.

The hydrocarbon resin portion of the filling mixture serves among other things to improve the adhesion and make the filling mixture flexible. In addition the hydrocarbon resin portion can accelerate the physical drying process and increase the hardness of the filling mixture. A further advantage of the use of a hydrocarbon resin portion is in the effective increase of the tackiness of the filling mixture.

A disadvantage of the hydrocarbon resin portion is to be seen in the fact that it increases the hydrophobicity of the filling mixture. That can lead to the fact that the filling mixture is only conditionally overpaintable with a paint. On the other hand the addition of the hydrocarbon resin portion as hydrophobic modifying agents leads to the fact that the filling mixture becomes less humidity-sensitive. In addition the stability of the hardened filling mixture against aqueous media is increased.

Hydrogenated aliphatic hydrocarbon resins are particularly suitable.

To the starting mixture from hydrocarbon resin, wax and polymer at least one functional additive is added. Such additives are herein called modifying agents.

Modifying agents are added to the starting mixture, in order to adapt certain characteristic characteristics to the filling task, like e.g.:
Reduction of the water and humidity stability
Optimization of the flowing characteristics
Improvement of the filler and pigment wetting
Adjustment of the elasticity,
Adjustment of the color,
Reduction of the brittleness
Improvement of the thermal and UV stability,
Reduction of the decrease,
Reduction of abrasiveness, i.e. the wear-causing effect on working on and processing tools.

The filling mixture can comprise further modifying agents, like e.g. softeners, flowing means, thickener, or coloring materials, in order to mention some examples.

The starting mixture forms a relatively smooth surface after hardening. For numerous applications however a filling material is demanded, which is similar to the substrate to be filled as far as the surface texture is concerned. Above all if natural substrates (for example wood) are to be filled, the surface of which is structured, textured or is porous, it requires at least one modifying agent.

To fulfill this purpose light filling materials, which exhibit a granularity and which can be distributed well and homogeneously in the starting mixture, are particularly suitable as modifying agents. Microspheres and micro caps are particularly favorable. For example metal or metallic oxide microspheres (Al₂O₃, ZrO₂, HfO₂, TiO₂, CeO₄, SiO₂, mixed oxides etc.) can be used. By mixing such a granular modifying agent pores in the filling mixture can be defined and a custom-made specific surface of the filling mixture can be obtained. Also microspheres or caps can be made from metal alloys or of polymers and used as modifying agents. Oxide ceramics microspheres or caps, resin-bound graphite spheres, Metallotspheres are also suitable.

The density of the filling mixture is reduced by addition of the light fillers. Thus the filling mixture becomes lighter and can more simply be transported in large quantities.

To the starting mixture coloring materials (color pigments) can be mixed as modifying agents. Depending upon the kind and quantity of the coloring materials, different colors can be adjusted from white to black. Thus the filling mixture can be designed in such a way that it corresponds to the color of the substrate to be filled.

In order to achieve a better firmness, fibers can be added as modifying agents. With the choice of the fibers it is to be made certain that the abrasiveness of the filling mixture does not exceed the desired values. Soft fibers, in particular natural fibers, are therefore better suitable than hard fibers. Depending upon length of the fibers cross-linking, respectively the internal cohesion of the filling mixture, can be improved.

The filling mixture can be manufactured in a simple way by mixing the components. It is favourable to first produce a starting mixture from the polymer, the wax, and the hydrocarbon resin and to then mix these with further modifying agents.

It is important that the modifying agents are compatible with the wax portion.

In the following tables examples of the composition of the filling mixture according to the invention are given.

| | portion in weight | portion in |
|---|---|---|
| Material | percentage | weight percentage |
| hydrogenated aliphatic | 15-40% | 20% |
| hydrocarbon resin | | |
| Polyolefin wax | 15-40% | 20% |
| E/VA Copolymer | 15-40% | 30% |
| metal-hollow-spheres | 5-30% | 25% |
| Color pigments | 1-10% | 5% |
| aromatic hydrocarbon | 15-40% | 28% |
| resin | | |
| Polyolefin wax | 15-40% | 28% |
| E/EA Copolymer | 15-40% | 28% |
| Al₂O₃ metal oxid micro | 5-25% | 10% |
| spheres | | |
| fibers | 0.1-5% | 2% |
| Color pigments | 1-10% | 4% |

A further important advantage of the filling mixture is that it hardens fast and hardly emits humidity, which could creep away into the substrate to be filled.

Depending upon the composition the filling mixture according to the invention is overpaintable or sprayable.

The filling mixture is particularly suitable for the machine processing of tears, holes and the like in a substrate.

The filling mixture in accordance with the invention is hot-melting. It is processed, in that it is melted. The filling mixture can be processed by means of cartouches and presses, or by means of Hotmelt devices.

The filling mixture has the advantage that it can be melted several times, without its characteristic characteristics noticeably changing.

Preferably, the filling mixture is designed in such a way that it can be processed in a temperature range between 120 degrees and 180 degrees. Fillers, which can be processed between 130 degrees and 150 degrees, are particularly preferential. Depending upon temperature the viscosity of the thermoplastic filling mixture can be affected.

The filling mixture is in particular suitable for filling and repairing wooden articles, in particular boards, veneers, planks and the like.

Preferably the filling mixture is manufactured in that a polymer portion, a wax portion and a resin portion are melted. Subsequently, the additives are added at the same time or successively by means of a disolver (agitator).

The filling mixture according to the invention can be manufactured also in an extruder. The filling mixture can be extruded in an extrusion equipment continuously into endlessly shaped semi-finished material in the form of round bars or flat bars and be then cut into shorter bars.

The filling mixture can be manufactured also as granulates or in flake form.

A filling mixture in accordance with invention is characterised particularly by the fact that it is only marginally abrasive. This means that a substrate, which was filled with the filling mixture, can be dressed with milling, drilling and grinding tools without problems. Due to the low abrasiveness of the filling mixture, a longer life-cycle of the milling, drilling and grinding tools is ensured.

A filling mixture in accordance with invention is characterised in that it does not harden as long as the temperature is kept within a given range and it can thus be better processed by machine, without the pumps, hoses, valves and the like to clog.

The filling mixture according to the invention is particularly suitable for repairing timber elements, which exhibit a growth, handling or processing damage.

1. Thermoplastic filling mixture comprising a mixture of
a polymer portion,
a wax portion,
a resin portion, and
at least one modifying agent.

2. Thermoplastic filling mixture according to claim 1, characterized in that the polymer portion comprises a Homopolymer and/or a copolymer.

3. Thermoplasticfilling mixture according to claim 1, characterized in that the polymer portion comprises one or more of the copolymers from the group vinyl acetate copolymer (VAc copolymer), Ethen Ethylacrylat copolymer (E/EA), Ethen vinyl acetate copolymer (ENA).

4. Thermoplastic filling mixture according to claim 1 , characterized in that the polymer portion lies between 15-40 weight percent.

5. Thermoplastic filling mixture according to claim 1, characterized in that the wax portion comprises polyolefin wax, amide wax, Montan wax, hydrocarbon wax, ENA wax and/or mixtures and/or modifications of the waxes mentioned.

6. Thermoplastic filling mixture according to claim 5, characterized in that the wax portion lies between 15-40 weight percent.

7. Thermoplasticfilling mixture according to claim 1, characterized in that the resin portion comprises a natural resin or modified natural resin, preferably hydrogenated aliphatic hydrocarbon resin and/or aromatic hydrocarbon resin.

8. Thermoplasticfilling mixture according to claim 7, characterized in that the resin portion lies between 15-40% weight percent.

9. Thermoplasticfilling mixture according to claim 1, characterized in that the modifying agent is selected from the group:
granular light fillers,
fibers,
coloring materials.

10. Thermoplastic filling mixture according to claim 9, characterized in that it comprises as granular light fillers metal microspheres or metallic oxide microspheres in a proportional portion between 5-30 weight percentage, preferably between 5 - 25 weight percentage.

11. Thermoplastic filling mixture according to claim 9, characterized in that the fibers lie between 0.1-5 weight percent.

12. Thermoplastic filling mixture according to claim 9, characterized in that the coloring materials lie between 1-10 weight percent.

13. A method for filling or repairing timber elements, comprising filling or repairing a timber element using a thermoplastic filling mixture containing a polymeric bonding agent, a wax portion, and a resin portion and at least one modifying agent.
